(19) United States
(12) Patent Application Publication
(10) Pub. No.: US 2006/0277334 A1
(43) Pub. Date: Dec. 7, 2006

(54) Portable data storage device

(75) Inventors: Wong Hoo Sim, Singapore (SG); Chian Yi Loo, Singapore (SG); Chin Fang Lim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/177,240

(22) Filed: Jul. 8, 2005

Related U.S. Application Data
(63) Continuation-in-part of application No. 11/142,691, filed on Jun. 1, 2005.

(51) Int. Cl. G06F 13/38; G06F 13/12

(52) U.S. Cl. 710/62

(57) ABSTRACT

A portable data storage device (100) for connection with an electronic device (51), the device (100) comprising: a first data connector (110) for connecting to a host port (50) of the electronic device (51), a second data connector (120) for connecting to a second portable data storage device (200), wherein the first and second data connectors (110, 120) comply with a common connector standard.

### CROSS REFERENCE TO RELATED APPLICATION

This application is a continuation-in-part of and claims the benefit from utility application Ser. No. 11/142,691, filed Jun. 1, 2005, the disclosure of which is incorporated herein by reference.

### TECHNICAL FIELD

The invention concerns a portable data storage device for connection with an electronic device.

### BACKGROUND OF THE INVENTION

Certain electronic devices such as desktop computers, notebook computers, personal digital assistants (PDA) and smart phones have a limited number of peripheral ports due to the physical constraints of the computing device. The Universal Serial Bus (USB) interface is widely embraced by computer manufacturers and is thus a generally accepted standard to enable interoperability and interface between computing devices (USB host) and peripheral devices (USB clients). It is not uncommon to use multiple peripheral devices at the same time, for example, a keyboard, mouse, speakers, thumbdrive/keydrive, MP3 player or PDA. Thus these days, one frequently finds themselves with all the USB ports used and must inconveniently detach one peripheral device in order to attach another to the same USB port.

A USB hub is one solution proposed. A USB hub connects several USB client devices to a USB host. A USB hub typically consists of a single upstream port to connect directly to computer or another hub and multiple downstream ports for connection with USB devices. However, a USB hub is an additional cost which only serves a single purpose and is therefore not an attractive purchase for most consumers. Furthermore, once all the ports of the USB hub are used, the same problem is experienced.

The rising popularity of digital video, and elaborate electronic presentations has seen an increase in the numbers of files exceeding 100 MB being swapped/transferred/shared between people nowadays. However, many existing/early generation flash memory-based portable storage devices have a capacity smaller than that, and are unable to facilitate the swapping/transferring/sharing of such large files.

### SUMMARY OF THE INVENTION

In a first preferred aspect, there is provided a portable data storage device for connection with an electronic device, the device comprising:

a first data connector for connecting to a host port of the electronic device,

a second data connector for connecting to a second portable data storage device,

wherein the first and second data connectors comply with a common connector standard.

The common connector standard may be Universal Serial Bus (USB) or IEEE 1394.

The first data connector may be a USB Type A male connector and the second data connector is a USB Type A female connector.

A firmware may be provided to copy a file allocation table of the second portable data storage device to a memory of the first portable data storage device when the second portable data storage device is operatively connected to the first portable data storage device. The memory may be volatile or non-volatile.

The firmware may rearrange the file allocation table of the second portable data storage device.

The firmware may present the first and second portable data storage devices as a single hardware device to the electronic device. The single hardware device may comprise file fragments in the first and second portable data storage devices that are readable as a single file by the electronic device.

The firmware may present the first and second portable data storage devices in separate drives when the first and second portable data storage devices are operatively connected to the electronic device.

The firmware may present the first and second portable data storage devices in a single drive, and the second portable data storage device is presented in a directory of the drive.

The file allocation tables of the first and second portable data storage devices may be read when a read/write operation request to the first or second portable data storage devices is received, wherein the file allocation table of the second portable data storage device is read from the memory of the first portable data storage device.

The file allocation tables of the first and second portable data storage devices may each be stored in non-volatile memory of the first and second portable data storage devices, respectively.

An audio decoder may be provided to process and replay audio files selected from the group consisting of MP3, WAV and WMA files.

A video decoder may be provided to process and replay video files selected from the group consisting of MPEG, AVI and ASF files.

The second data connector may enable connection to a non mass storage class device such as, for example, printers, scanners, keyboards, mice, joysticks, flight yokes, digital cameras, webcams, scientific data acquisition devices, modems, or speakers.

A third data connector may be provided for connecting with a third portable data storage device or non-storage device and create a hub, wherein the first, second and third data connectors comply with a common connector standard.

Each portable data storage device may have a locking means to one another such as, for example, a mechanical lock, adhesive tape or adhesive tabs.

In a second aspect, there is provided a method for cascading at least two portable data storage devices to connect with an electronic device, the method comprising:

operatively connecting a first portable data storage device to a host port of the electronic device;

operatively connecting a second portable data storage device to the first portable data storage device;

wherein a file allocation table of the second portable data storage device is copied to a memory of the first portable data storage device when the second portable data storage device is operatively connected to the first portable data storage device.

The method may further comprise operatively connecting additional portable data storage devices, wherein the file allocation table of each additional portable data storage device is ultimately copied to the memory of the first portable data storage device.

The method may comprise breaking up a file of a size greater than a storage capacity of a portable data storage device into a plurality of fragments and storing the fragments in each operatively connected data storage device. The plurality of fragments stored in the operatively connected data storage devices may be readable as a single file in the electronic device.

In a third aspect, there is provided a portable data storage device for connection with an electronic device, the device comprising:

a first data connector for connecting to a host port of the electronic device;

memory for receiving and storing data from the electronic device via the host port; and

a second data connector for connecting to a second portable data storage device thereby to facilitate communication between the electronic device and the second portable data storage device via the first data connector;

wherein the first and second data connectors comply with a common connector standard.

The firmware may manage the FAT and data in the memory to allow for a file larger than a storage capacity of the first portable data storage device to be fragmented and stored in the first and the second portable data storage devices. The fragmented files may be read as a single file in the electronic device.

### BRIEF DESCRIPTION OF THE DRAWINGS

An example of the invention will now be described with reference to the accompanying drawings, in which:

FIG. 1 is a block diagram of a device in accordance with the present invention, prior to use;

FIG. 2 is a block diagram of the device in accordance with another embodiment of the present invention, prior to use;

FIG. 3 is a block diagram of the operation of the device in accordance with the present invention, in use;

FIG. 4 is a perspective view of the device in accordance with the present invention;

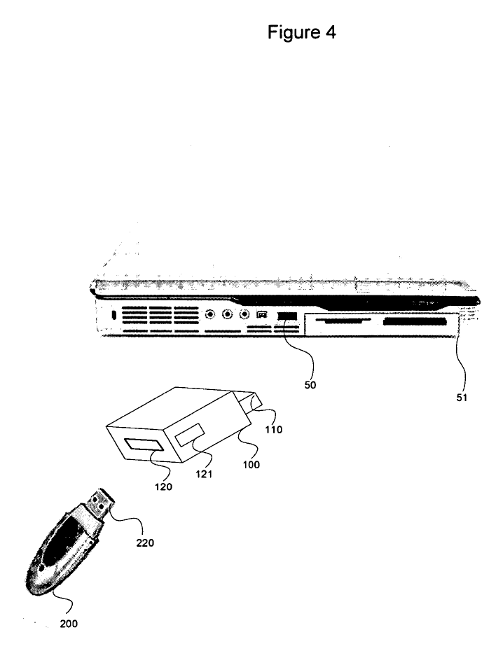

FIG. 5 is a perspective view of the device in accordance with another embodiment of the present invention; and

FIG. 6 is a perspective view of the device with various locking mechanisms.

### DETAILED DESCRIPTION OF THE DRAWINGS

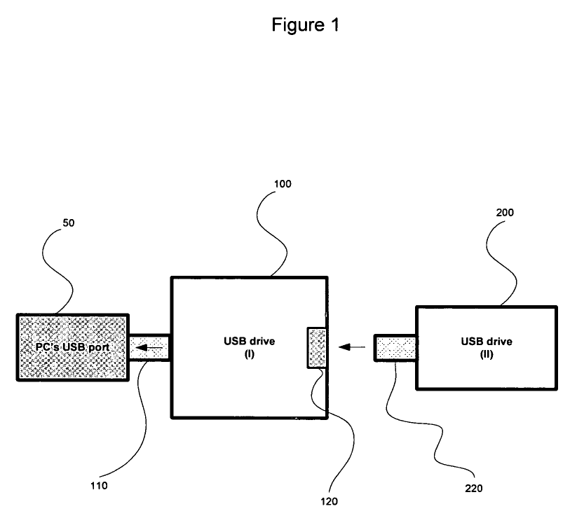

FIG. 1 and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

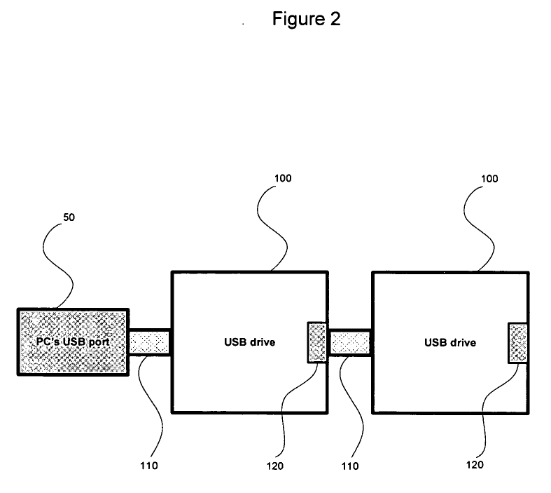

Referring to FIG. 1, a portable data storage device 100 is provided for connection with a computer 51. The first device 100 includes flash memory to store information and data in a non-volatile state and complies with the Universal Serial Bus (USB) standard. In one embodiment, the storage capacity of the first device 100 may range from several MB to several GB. The first device 100 comprises a USB Type A male connector 110 at one side and a USB Type A female connector 120 at the opposite side of the first device 100. In use, the USB Type A male connector 110 connects to a host port 50 of the computer 51 and the USB Type A female connector 120 connects to a second portable data storage device 200. The second device 200 which is a normal USB storage device such as, for example, a USB storage drive, a portable hard disk drive and so forth comprises a USB Type A male connector 220 to connect with the USB Type A female connector 120 of the first device 100. In one embodiment, the storage capacity of the second device 200 may be several GB. In another embodiment shown in FIG. 2, a device identical to the first device 100 is also connectable to the USB Type A female connector 120 of the first device 100. There may be no limit to the number of first devices 100 that can be connected to one another.

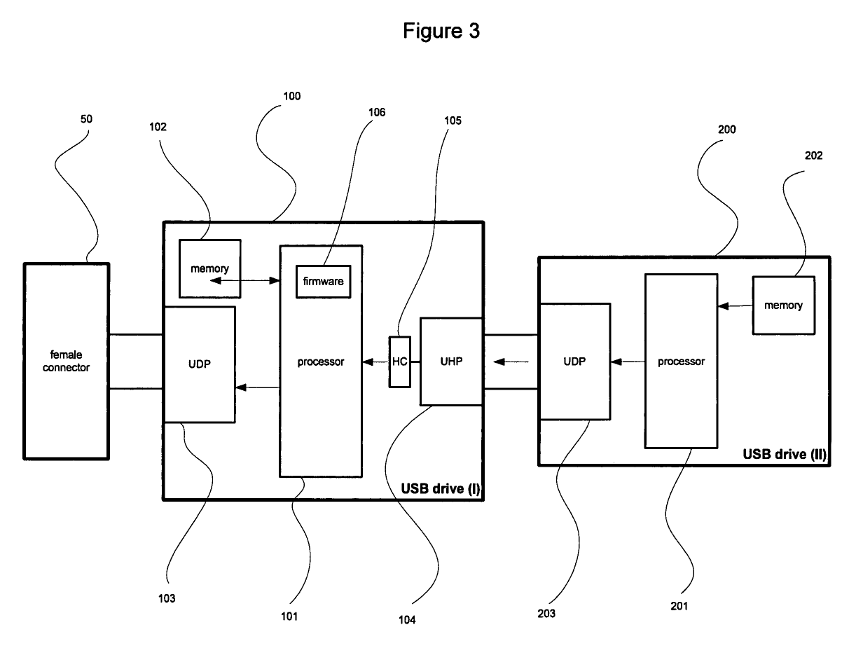

Referring to FIG. 3, the first device 100 comprises a processor 101, memory 102, USB device port (UDP) 103, USB host port (UHP) 104 and USB host controller 105. A mass storage class driver is stored in firmware 106 to allow the first device 100 to interface with the second device 200. Typically, firmware 106 resides in a memory of the processor 101. A file allocation table (FAT 1) is stored on the first device 100 to provide a map of where files are physically stored on the flash memory of the first device 100. FAT 1 is stored in the flash memory 102.

The second device 200 also comprises a processor 201, memory 202, and USB device port (UDP) 203. The second device 200 includes flash memory to store information and data in a non-volatile state and complies with the Universal Serial Bus (USB) standard. The memory 202 stores a file allocation table (FAT 2) which provides a map of where files are physically stored on the flash memory of the second device 200. The USB host controller 105 and UHP 104 of the first device 100 enable communication with second device 200 via UDP 203.

The second device 200 is operatively connected to the first device 100 by inserting USB Type A male connector 220 into USB Type A female connector 120. When the connection is detected, the firmware 106 of the first device 100 reads the memory 202, makes a copy of FAT 2 and stores it to the memory 102. In one embodiment, the firmware 106 rearranges FAT 2 in memory 102 to combine both FATs and allow the computer 51 to identify the operatively connected (cascaded) devices 100, 200 as a single device.

The first device 100 is operatively connected to the computer 51 by inserting the USB Type A male connector 120 into a USB Type A female connector 50. When the connection is detected by the operating system of the computer 51, it interfaces with the first device 100 via its mass storage class driver. When the operating system performs a read/write operation on the devices 100, 200, it reads/writes to the FAT of the device 100 only. The firmware 106 manages the read/write operations to the second device 200. During a read operation for a file stored on the second device 200, the copy of FAT 2 stored in the memory 102 of first device 100 is read by the operating system. During a write operation to the second device 200, the FAT 2 is updated and a corresponding update to the copy of FAT 2 is also made or the updated FAT 2 is copied again to the first device 100 when the write operation is completed.

The firmware 106 enables the first device 100 and the second device 200 to be detected as a single hardware storage device to the computer 51. In one embodiment, the files stored on both devices 100, 200 are presented in separate drives in a similar manner as though the hardware storage device was partitioned or as separate hardware storage devices installed. In another embodiment, the files of the first device 100 are presented in a single drive, and the files of the second device 200 are presented in a directory of that drive.

In another embodiment, the first device 100 is modified to incorporate an audio decoder or video decoder to enable processing and replay of audio or video files stored on the first device without requiring any processing by the computer 51. The modified first device 100 may include a digital signal processor (DSP) chip, audio and video codecs and an amplifier. The modified first device 100 may include output jacks for audio and video output and be operatively connectable with a power source such as battery holder assembly to enable portable playback of the audio and video files. For example, the modified first device 100 may be operatively connected with the battery holder assembly of the Creative Muvo™ MP3 player.

Other non mass storage class devices may also connect to the first device 100 via USB Type A female connector 120. These other devices may include printers, scanners, keyboards, mice, joysticks, flight yokes, digital cameras, webcams, scientific data acquisition devices, modems, speakers, telephones, or video phones.

Another USB Type A female connector 121 may be included with the first device 100 for connecting to a third portable data storage device or other devices without a file allocation table. This creates a hub in which all connecting devices comply with the Universal Serial Bus (USB) standard.

The first device 100 may have a LED to visually indicate when a read/write operation is being performed by the first device 100.

Although a second device 200 has been described, it is possible that the second device 200 may be a first device 100 in accordance with the present invention. In such a scenario, a cascading effect is created where a series of first devices 100 are connected to each other and copies of all the FATs of the devices 100 are ultimately stored in the memory 102 of the first device 100 which is operatively connected to the computer 51. As each first device 100 is connected to a previous one, its FAT is copied to the previous one and so forth until a copy of the FAT reaches the first device 100 operatively connected to the notebook 51. Alternatively, each FAT is directly copied to the first device 100 operatively connected to the computer 51. The firmware 106 enables all the first devices 100 to be detected as a single hardware device by the computer 51.

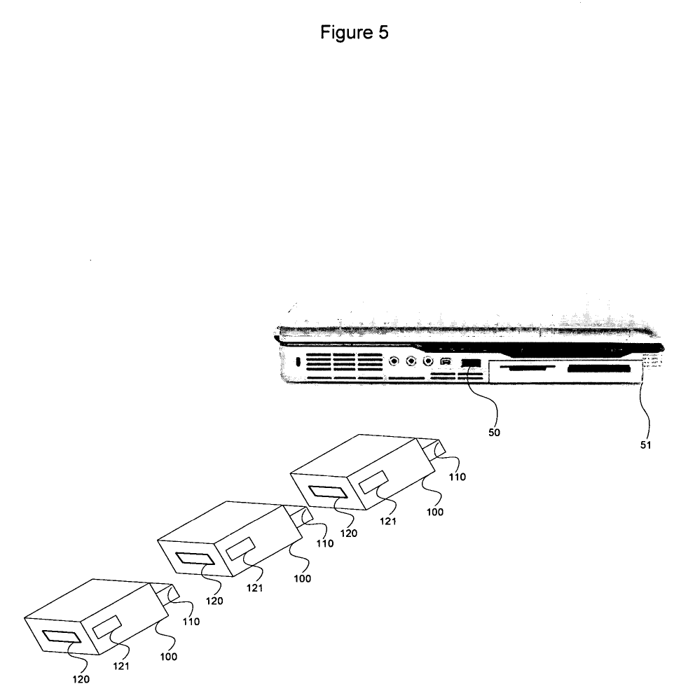

The FAT of the first device 100 may also be managed to be able to “join” fragmented files from several first devices 100 that are connected to one another into a single readable file. Such a feature facilitates the storage of files larger than the storage capacity of each device 100 in more than one device 100. For example, when each device 100 has a capacity of 128 MB, two devices 100 will be able to store a file of approximately 256 MB, three devices 100 will be able to store a file of approximately 384 MB and so forth. FIG. 5 shows three devices 100 being connected to one another and to a computer 51. When a file is fragmented and stored as such, the order that the devices 100 are connected must not be changed when re-connecting to a computer 51. When the operating system of the computer 51 detects the plurality of devices 100 connected to one another, it can read the various file fragments as a single large file. Switching the order that the devices 100 are arranged would cause the file fragments in each device 100 to be unable to be combined into a single file. This is due to how the firmware 106 in the device 100 manages the FAT and data in each device 100. The first device 100 may read the FAT of the second and subsequent devices 100 and attain information in relation to the size and order of the file fragments in each device 100.

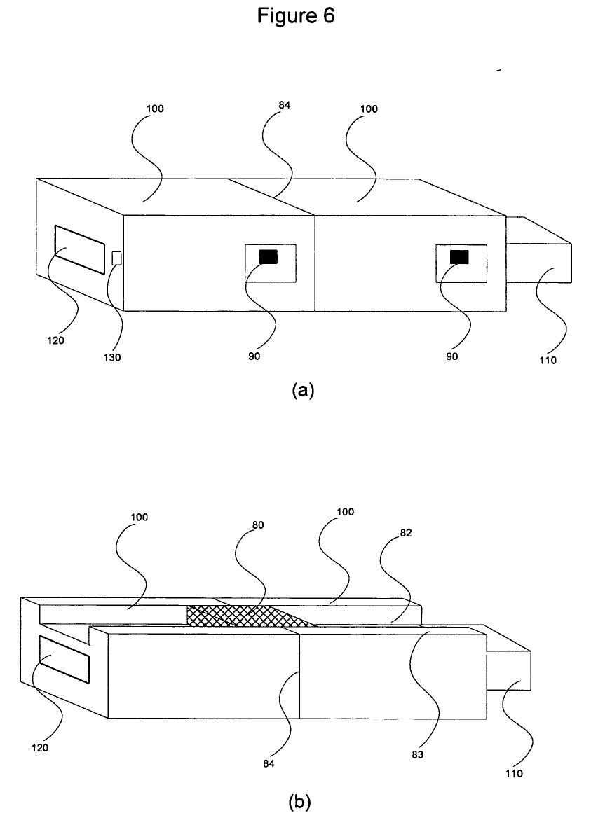

In order to ensure the arrangement of the plurality of devices 100 connected together are not mixed up, the devices 100 may be locked together, either by mechanical means or otherwise. Referring to FIG. 6a, there is shown a device 100 with a mechanical switch/tab 90 that is toggled to lock into a receptor 130 an adjoining device 100. The switch/tab 90 may include a hook that latches onto the receptor 130 of the preceding device 100. Referring to FIG. 6b, there is shown another method of joining two devices 100 with an adhesive tab 80. The tab 80 acts like “scotchtape” to prevent the separation of the two devices 100. Each device 100 may have a channel 82(as shown) or there may be a depression sufficiently big and able to fit the tab 80 over a joining seam of two devices 100, and allow the tab 80 to be flush with the top surface 83 of the device 100. At least one surface of the tab 80 should have a layer of non-permanent adhesives. An adhesive tape may also be used over the connection seam 84 to secure two devices 100 together.

If the file fragments are corrupted while in the device 100 and are unable to be re-combined, there may be software which can re-combine the file fragments into a single readable file in a computer 51. It is also possible to remove file fragments from the device 100 to restore the storage capacity of the device 100.

Although the USB standard has been described, it is envisaged that the present invention may use IEEE 1394 Firewire or other standards. Although USB Type A connectors have been described, it is possible to use USB Type B, USB Type Mini A and USB Type Mini B connectors.

Although flash memory has been described, it is envisaged that other types of memory may be used including solid state disks, hard disks or mini hard disks.

It will be appreciated by persons skilled in the art that numerous variations and/or modifications may be made to the invention as shown in the specific embodiments without departing from the scope or spirit of the invention as broadly described.

The present embodiments are, therefore, to be considered in all respects illustrative and not restrictive.

We claim:

1. A portable data storage device for connection with an electronic device, the device comprising:
a first data connector for connecting to a host port of the electronic device,
a second data connector for connecting to a second portable data storage device,
wherein the first and second data connectors comply with a common connector standard.

2. The device according to claim 1, wherein the common connector standard is Universal Serial Bus (USB) or IEEE 1394.

3. The device according to claim 2, wherein the first data connector is a USB Type A male connector and the second data connector is a USB Type A female connector.

4. The device according to claim 1, further comprising a firmware to copy a file allocation table of the second portable data storage device to a memory of the first portable data storage device when the second portable data storage device is operatively connected to the first portable data storage device.

5. The device according to claim 4, wherein the firmware rearranges the file allocation table of the second portable data storage device.

6. The device according to claim 4, wherein the memory is volatile or non-volatile.

7. The device according to claim 4, the firmware presents the first and second portable data storage devices as a single hardware device to the electronic device.

8. The device according to claim 7, the firmware presents the first and second portable data storage devices in separate drives when the first and second portable data storage devices are operatively connected to the electronic device.

9. The device according to claim 7, wherein the firmware presents the first and second portable data storage devices in a single drive, and the second portable data storage device is presented in a directory of the drive.

10. The device according to claim 7, wherein the file allocation tables of the first and second portable data storage devices are read when a read/write operation request to the first or second portable data storage devices is received, wherein the file allocation table of the second portable data storage device is read from the memory of the first portable data storage device.

11. The device according to claim 10, wherein the file allocation tables of the first and second portable data storage devices are each stored in non-volatile memory of the first and second portable data storage devices, respectively.

12. The device according to claim 7, wherein the single hardware device comprises file fragments in the first and second portable data storage devices that are readable as a single file by the electronic device.

13. The device according to claim 1, further comprising an audio decoder to process and replay audio files selected from the group consisting of MP3, WAV and WMA files.

14. The device according to claim 1, further comprising a video decoder to process and replay video files selected from the group consisting of MPEG, AVI and ASF files.

15. The device according to claim 1, wherein the second data connector enables connection to a non mass storage class device, the device being selected from the group consisting of printers, scanners, keyboards, mice, joysticks, flight yokes, digital cameras, webcams, scientific data acquisition devices, modems, or speakers.

16. The device according to claim 1, further comprising a third data connector for connecting with a third portable data storage device or non-storage device and create a hub, wherein the first, second and third data connectors comply with a common connector standard.

17. The device according to claim 1, further including a locking means to the second portable data storage device, wherein the locking means is selected from the group comprising: a mechanical lock, adhesive tape and adhesive tabs.

18. A method for cascading at least two portable data storage devices to connect with an electronic device, the method comprising:
operatively connecting a first portable data storage device to a host port of the electronic device;
operatively connecting a second portable data storage device to the first portable data storage device;
wherein a file allocation table of the second portable data storage device is copied to a memory of the first portable data storage device when the second portable data storage device is operatively connected to the first portable data storage device.

19. The method according to claim 18, further comprising operatively connecting additional portable data storage devices, wherein the file allocation table of each additional portable data storage device is ultimately copied to the memory of the first portable data storage device.

20. The method according to claim 19, wherein a file of a size greater than a storage capacity of a portable data storage device is broken up into a plurality of fragments and stored in each operatively connected data storage device.

21. The method according to claim 20, wherein the plurality of fragments stored in the operatively connected data storage devices are readable as a single file in the electronic device.

22. A portable data storage device for connection with an electronic device, the device comprising:
a first data connector for connecting to a host port of the electronic device;
memory for receiving and storing data from the electronic device via the host port; and
a second data connector for connecting to a second portable data storage device thereby to facilitate communication between the electronic device and the second portable data storage device via the first data connector;
wherein the first and second data connectors comply with a common connector standard.

23. The device according to claim 22, further comprising firmware to copy a file allocation table of the second portable data storage device to a memory of the first portable data storage device when the second portable data storage device is operatively connected to the first portable data storage device.

24. The device according to claim 22, wherein the common connector standard is Universal Serial Bus (USB) or IEEE 1394.

25. The device according to claim 23, wherein the firmware manages the FAT and data in the memory to allow for a file larger than a storage capacity of the first portable data storage device to be fragmented and stored in the first and the second portable data storage devices.

26. The device according to claim 25, wherein the fragmented files are read as a single file in the electronic device.
